(19) United States
(12) Patent Application Publication
(10) Pub. No.: US 2026/0035595 A1
(43) Pub. Date: Feb. 5, 2026

(54) POLISHING COMPOSITION WITH PRINTED PARTICLES AND METHOD FOR FABRICATING PRINTED PARTICLES

(71) Applicant: NANYA TECHNOLOGY CORPORATION, NEW TAIPEI CITY (TW)

(72) Inventor: KUAN-CHI LIN, NEW TAIPEI CITY (TW)

(21) Appl. No.: 18/882,142

(22) Filed: Sep. 11, 2024

Related U.S. Application Data
(62) Division of application No. 18/794,068, filed on Aug. 5, 2024.

(51) Int. Cl. C09G 1/02; C09K 3/14

(52) U.S. Cl. CPC C09G 1/02; C09K 3/1409

(57) ABSTRACT

The present application discloses a polishing composition including printed particles and a method for fabricating the printed particles. The polishing composition includes a liquid carrier; and printed particles dispersed in the liquid carrier. The printed particles are fabricated by additive manufacturing. The additive manufacturing is one of two-photon polymerization, projection microstereolithography, and direct ink writing.

### CROSS-REFERENCE TO RELATED APPLICATION

This application is a divisional application of U.S. Non-Provisional application Ser. No. 18/794,068 filed Aug. 5, 2024, which is incorporated herein by reference in its entirety.

### TECHNICAL FIELD

The present disclosure relates to a polishing composition with printed particles and a method for fabricating the printed particles.

### DISCUSSION OF THE BACKGROUND

Semiconductor devices are used in a variety of electronic applications, such as personal computers, cellular telephones, digital cameras, and other electronic equipment. The dimensions of semiconductor devices are continuously being scaled down to meet the increasing demand of computing ability. However, a variety of issues arise during the scaling-down process, and such issues are continuously increasing. Therefore, challenges remain in achieving improved quality, yield, performance, and reliability and reduced complexity.

This Discussion of the Background section is provided for background information only. The statements in this Discussion of the Background are not an admission that the subject matter disclosed in this section constitutes prior art to the present disclosure, and no part of this Discussion of the Background section may be used as an admission that any part of this application, including this Discussion of the Background section, constitutes prior art to the present disclosure.

### SUMMARY

One aspect of the present disclosure provides a polishing composition including a liquid carrier; and printed particles dispersed in the liquid carrier. The printed particles are fabricated by additive manufacturing.

Another aspect of the present disclosure provides a polishing composition including a liquid carrier; first printed particles dispersed in the liquid carrier; and second printed particles dispersed in the liquid carrier. The first printed particles and the second printed particles are fabricated by additive manufacturing. A dimension of the first printed particles and a dimension of the second printed particles are different.

Another aspect of the present disclosure provides a method for fabricating printed particles including preparing a light-sensitive material and placing the light-sensitive material on a displacement platform; activating a femtosecond laser to generate femtosecond laser beams; modulating the femtosecond laser beams with an external light path modulation unit; using a computer to control an image capture apparatus to capture a first layer of cross-section graphs of the printed particles, such that the modulated femtosecond laser beams form parallel beams arranged according to the first layer of cross-section graphs; focusing the parallel beams, by focusing lens, in the light-sensitive material to form a planar graph composed of multiple focal points, where the light-sensitive material at all focal points is solidified, thereby achieving one-time projection forming for the first layer of cross-section structures of the first layer of cross-section graphs of the printed particles; using the computer to control the displacement platform to move by a distance equal to the thickness of one layer of the cross-section of the printed particles, with the movement direction of the displacement platform being parallel to the direction in which the femtosecond laser beams radiate the light-sensitive material; controlling the image capture apparatus, via the computer, to capture subsequent layers of cross-section graphs of the printed particles layer by layer; and after a subsequent layer of cross-section graphs of the printed particles is formed, using the computer to control the displacement platform to move by a distance equal to the thickness of one layer of the cross-section of the printed particles until the printed particles are formed.

Due to the use of printed particles formed by additive manufacturing, which exhibit less structural variation (e.g., shape, dimension, surface charge, etc.,) between individual particles, the batch-to-batch variation in CMP operations using the polishing composition may be reduced. As a result, the process stability of CMP operations may be improved, and process control may be simplified. Furthermore, the shape, dimension, surface charge, polarity, and/or size distribution of the printed particles can be customized by additive manufacturing to meet the requirements of various processes.

The foregoing has outlined rather broadly the features and technical advantages of the present disclosure in order that the detailed description of the disclosure that follows may be better understood. Additional features and advantages of the disclosure will be described hereinafter and form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRA WINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

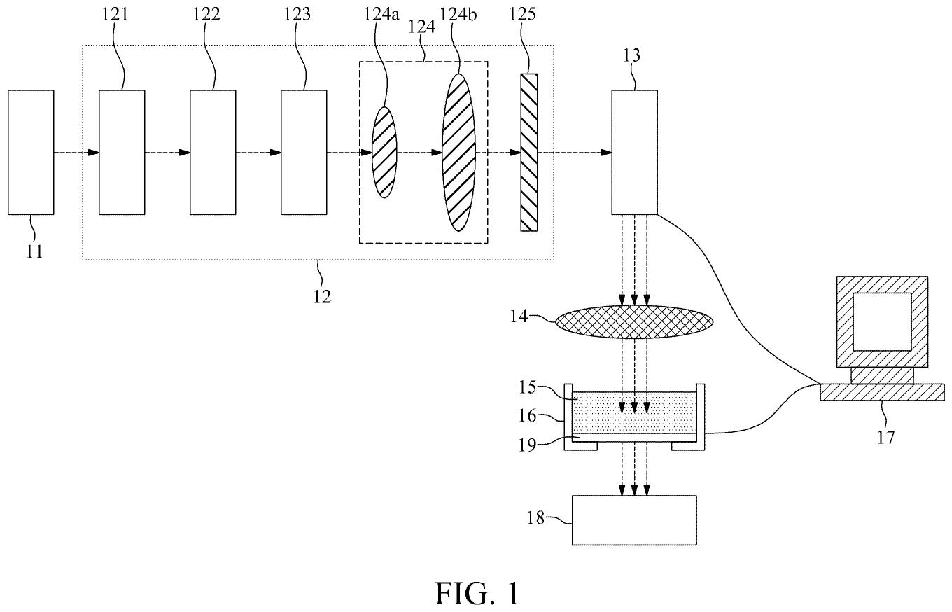

FIG. 1 is a schematic structural diagram illustrating a system for fabricating printed particles by two-photon polymerization using a femtosecond laser of the present disclosure; and

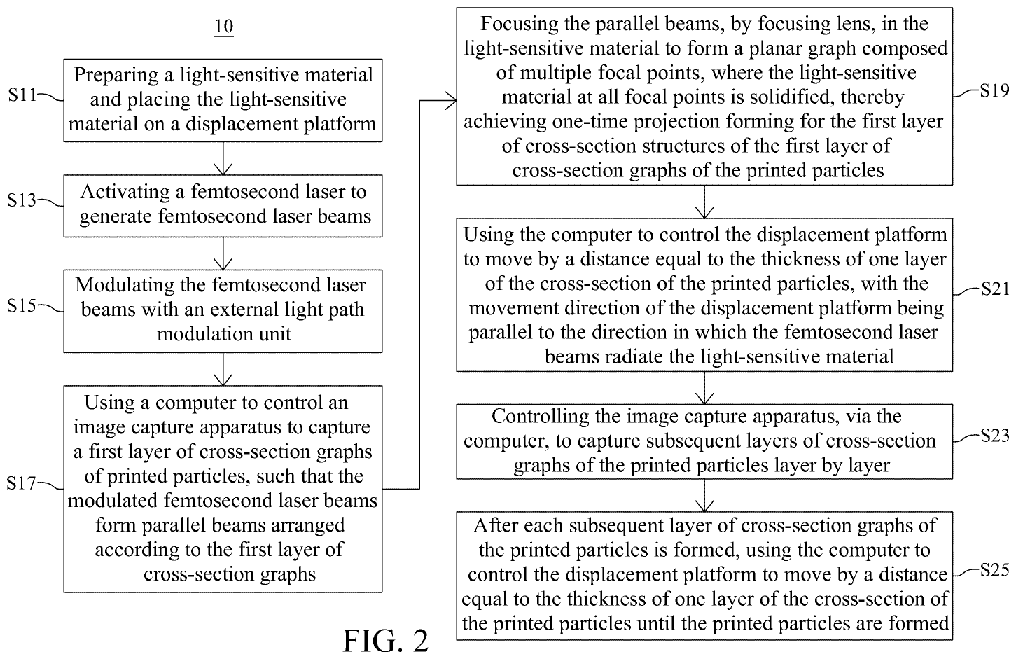

FIG. 2 is a flow chart illustrating the method for the fabricating the printed particles by two-photon polymerization using a femtosecond laser of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

It should be understood that when an element or layer is referred to as being “connected to” or “coupled to” another element or layer, it can be directly connected to or coupled to another element or layer, or intervening elements or layers may be present.

It should be understood that, although the terms first, second, etc. may be used herein to describe various elements, these elements should not be limited by these terms. Unless indicated otherwise, these terms are only used to distinguish one element from another element. Thus, for example, a first element, a first component or a first section discussed below could be termed a second element, a second component or a second section without departing from the teachings of the present disclosure.

Unless the context indicates otherwise, terms such as “same,” “equal,” “planar,” or “coplanar,” as used herein when referring to orientation, layout, location, shapes, sizes, amounts, or other measures do not necessarily mean an exactly identical orientation, layout, location, shape, size, amount, or other measure, but are intended to encompass nearly identical orientation, layout, location, shapes, sizes, amounts, or other measures within acceptable variations that may occur, for example, due to manufacturing processes. The term “substantially” may be used herein to reflect this meaning. For example, items described as “substantially the same,” “substantially equal,” or “substantially planar,” may be exactly the same, equal, or planar, or may be the same, equal, or planar within acceptable variations that may occur, for example, due to manufacturing processes.

As referred to herein, all compositional percentages are specified as being by weight (wt %) or by moles (mol %) of the total composition, unless otherwise disclosed. Disclosures of ranges are, unless specified otherwise, inclusive of endpoints and include all distinct values and further divided ranges within the entire range.

In the present disclosure, a semiconductor device generally means a device which can function by utilizing semiconductor characteristics, and an electro-optic device, a light-emitting display device, a semiconductor circuit, and an electronic device are all included in the category of the semiconductor device.

It should be noted that, in the description of the present disclosure, above (or up) corresponds to the direction of the arrow of the direction Z, and below (or down) corresponds to the opposite direction of the arrow of the direction Z.

In a Chemical Mechanical Planarization (CMP) operation, the substrate (e.g., wafer) to be polished is mounted on a carrier assembly and positioned in contact with a polishing pad within a CMP polishing tool. The carrier assembly applies controlled pressure to the substrate against the polishing pad. An external driving force moves the substrate and polishing pad relative to each other. The relative motion between the substrate and polishing pad abrades and removes a portion of the material from the surface of the substrate, thereby polishing the substrate.

Polishing compositions (also known as polishing slurries, CMP slurries, and CMP compositions) for polishing various metal (such as tungsten) and non-metal (such as silicon oxide) layers on a semiconductor substrate may include abrasive particles suspended in an aqueous solution and various chemical additives such as oxidizers, chelating agents, catalysts, topography control agents, buffers, and the like.

The polishing process may be further enhanced by the chemical activity of the polishing composition and/or the mechanical action of abrasive particles suspended in the polishing composition.

In the present disclosure, a polishing composition may be provided. In some embodiments, the polishing composition may include a liquid carrier and (colloidal) printed particles dispersed in the liquid carrier. In some embodiments, the printed particles may be formed by additive manufacturing. In some embodiments, the printed particles may be formed by, for example, three dimensional printing (3D printing).

In some embodiments, the printed particles may be formed by, for example, two-photon polymerization, projection microstereolithography, direct ink writing, or other applicable additive manufacturing technology.

In some embodiments, the printed particles may be formed by, for example, two-photon polymerization technology. The technology may introduce femtosecond lasers as a light source into the field for fabricating the printed particles. Generally, the technology utilizes the femtosecond lasers with longer wavelength as the light source, laser beams are focused by a focusing objective lens on a light-sensitive material to be solidified, and the light-sensitive material generates a polymerization reaction at a focal point through two-photon absorption action; however, two-photon absorption is not generated at other places of a light path due to lower laser intensity; meanwhile, a corresponding single-photon absorption process is not generated due to lower laser energy; and therefore, two-photon polymerization is only limited to the focal point. When the focal point of the lasers moves inside the light-sensitive material, the light-sensitive material is solidified along a track of the focal point, and the light-sensitive material which is not solidified is removed by an organic solvent, so as to realize the crafting for the light-sensitive material.

FIG. 1 is a schematic structural diagram illustrating a system for fabricating printed particles by two-photon polymerization using a femtosecond laser of the present disclosure.

With reference to FIG. 1, the system for fabricating printed particles (also referred to as the target article) by two-photon polymerization using a femtosecond laser may include a femtosecond laser 11, an external light path modulation unit 12, an image capture apparatus 13, a focusing lens 14, a light-sensitive material 15, a displacement platform 16, a computer 17, and a monitoring apparatus 18.

In some embodiments, the femtosecond laser 11 is configured to generate femtosecond lasers. The external light path modulation unit 12 modulates the femtosecond lasers. The image capture apparatus 13 captures cross-section graphs of the target article layer by layer, so that the modulated femtosecond lasers form parallel beams arranged according to all layers of the cross-section graphs. The focusing lens 14 focuses the parallel beams arranged according to all layers of the cross-section graphs in the light-sensitive material 15 to form a planar graph composed of a plurality of focal points, where the light-sensitive material at all the focal points is solidified, thus realizing one-time projection forming for each layer of cross-section structures of the target article. The displacement platform 16 carries out fine adjustments for the position of the light-sensitive material 15 placed on it. The computer 17 controls the displacement platform 16 and the image capture apparatus 13. The monitoring apparatus 18 monitors the solidification process for the light-sensitive material 15 in real time.

In some embodiments, a glass slide 19 may be fixed on the displacement platform 16 and is configured to hold the light-sensitive material 15. In some embodiments, the monitoring apparatus 18 may use a CCD (Charged Coupled Device) image sensor as a core component. Additionally, a scanning array lens may be arranged between the image capture apparatus 13 and the focusing lens 14, further improving the process speed due to the higher response speed of the scanning array lens.

In some embodiments, the image capture apparatus 13 can be controlled by the computer 17 to form all layers of the cross-section graphs of the target article. One beam of femtosecond lasers can form a plurality of parallel femtosecond laser beams arranged according to all layers of the cross-section graphs, allowing layer-by-layer solidification of the light-sensitive material. Consequently, the displacement platform 16 only needs to move along the cross-section thickness of the target article.

In some embodiments, the image capture apparatus 13 may not form all layers of the cross-section graphs of the target article. Instead, the image capture apparatus 13 may divide one beam of femtosecond lasers into a plurality of parallel femtosecond laser beams, enabling multifocal parallel solidification on the light-sensitive material to manufacture multiple target articles simultaneously. Accordingly, the displacement platform 16 moves according to a preset track, which corresponds to the distribution of all solidifying points of the target article to be fabricated.

In some embodiments, a dynamic image capture apparatus is adopted as the image capture apparatus 13. The dynamic image capture apparatus may include a plurality of pixel units, where the pixel units, which are in the opening state under the control of the computer 17, form all the layers of the cross-section graphs of the target article on the dynamic image capture apparatus. Each pixel unit of the dynamic image capture apparatus is separately opened or closed under the control of the computer 17; and when the femtosecond lasers 11 are radiated on the dynamic image capture apparatus, each pixel unit in an opening state reflects or transmits the femtosecond lasers 11, so that one beam of femtosecond lasers 11 may be divided into a plurality of beams of femtosecond lasers 11 arranged according to the specific shape to realize the target article.

In some embodiments, the external light path modulation unit 12 may include but not limited to: a regenerative amplifier 121, a shutter 122, an attenuator 123, a collimating lens group 124 and an aperture stop 125 that are sequentially arranged on an advance path of the femtosecond lasers. The femtosecond lasers generated by the femtosecond laser 11 are ultra-short pulse lasers and need to be modulated by the external light path modulation unit 12 to realize the solidification for the light-sensitive material 15.

Detailedly, during the solidification process, the regenerative amplifier 121 may amplify the energy of the femtosecond lasers; and the on-off state of the beams, the energy of which is amplified, is controlled by the shutter 122, and the size of the energy of the beams is adjusted by the attenuator 123. Through the control of the attenuator 123 on the beams, the central intensity at the focal point of each beam can be adjusted, so as to control the process resolution. Then, the collimating lens group 124 is used, where the collimating lens group 124 includes a short-focus lens 124a and a long-focus lens 124b. Since the energy of the lasers is in Gaussian distribution in space, the light intensity of the beams of the lasers is higher at the edges than the center; in order to reduce the difference of the light intensity of image capturing cross sections caused by non-uniform distribution of the light intensity of cross sections of the beams, the collimating lens group 124 needs to collimate and expand the beams, so that the distribution of the light intensity at the central area of the beams of the lasers is relatively uniform. Next, the aperture stop 125 is used for filtering the edges of the beams to obtain beams of femtosecond lasers with approximately uniform distribution of the light intensity of the cross sections.

It should be noted that, besides the above devices having modulating action for the femtosecond lasers, other devices may also be arranged on the advance path of the femtosecond lasers and in front of the image capture apparatus 13 according to the actual requirement. For example, in order that the structure of the system for fabricating printed particles is more compact, a whole reflector may be arranged on the advance path of the femtosecond lasers and behind the aperture stop 125.

In some embodiments, the controlling of the image capture apparatus 13 by the computer 17 may include: the structure of the target article may be modeled by the computer 17, and a model obtained through modeling is converted into digital voltage signals to load on the image capture apparatus 13 by the computer 17, so as to form all layers of cross-section graphs of the target article. The computer 17 can realize computer aided design by a software control unit arranged in the computer 17, a three-dimensional model is established for the target article to be fabricated, the established three-dimensional model is divided into a plurality of layers of cross-section graphs, and each layer of the cross-section graphs is decomposed point by point to obtain a corresponding layer of cross-section graphs, which is composed of a plurality of points. It should be noted that, optionally, aided design software in the above software control unit may be selected from the existing commercial software, such as CAD (Computer Aided Design), where optionally, a CAD file may be in an STL (Standard Template Library) file format.

In some embodiments, the light-sensitive material 15 may include a solution of a first photopolymer precursor, a second photopolymer precursor, a photoinitiator, and a photoinhibitor. In some embodiments, the light-sensitive material 15 may include a solution of colloidal nanoparticles of a first material with a first photopolymer precursor and a second photopolymer precursor, a photoinitiator, and a photoinhibitor.

In some embodiments, the first material may include, for example, silicon oxide, aluminum oxide, ceric oxide, or a combination thereof. In some embodiments, the refractive index of the photopolymer precursor mixture must match that of the first material to obtain transparent ink to eliminate photo extinction and scattering. In some embodiments, the heat conductivity of the light-sensitive material 15 must be high to avoid instant vaporization by the femtosecond laser with megawatts of peak power. In some embodiments, the light-sensitive material 15 must be homogeneous and well-dispersed to maintain nanoscale resolution as well as to avoid localized vaporization.

In some embodiments, the nanoparticles may include polyethylene glycol functional groups which are chemically attached to the nanoparticles.

In some embodiments, the size of the nanoparticles may be between about 5 nm and about 50 nm, or between about 8 nm and about 25 nm. In some embodiments, the light-sensitive material 15 may include the (colloidal) nanoparticles in a range from a lower limit selected from 20, 25, 30, 35, 40, 45, 50, and 55 percent by weight (wt %), to an upper limit selected from 30, 35, 40, 45, 50, 55, and 60 wt %, where any lower limit may be paired with any mathematically feasible upper limit.

In some embodiments, the mixture of the first photopolymer precursor and second photopolymer precursor may have the same refractive index as the first material and can be fully removed during any subsequent annealing processes. In some embodiments, the mixture of the first photopolymer precursor and second photopolymer precursor may have the same refractive index as the nanoparticles.

In some embodiments, the first photopolymer precursor and second photopolymer precursor may be small molecule acrylates. In some embodiments, the first photopolymer precursor and second photopolymer precursor may be with a molecular weight of less than 10,000 grams per mole. In some embodiments, the refractive index of the mixture of the first photopolymer precursor and second photopolymer precursor may be about 1.5. In some embodiments, the mixture of the first photopolymer precursor and second photopolymer precursor may be a liquid at room temperature. In some embodiments, the suitable photopolymer precursors may be selected from those that are composed of carbon, oxygen, and hydrogen and where the photopolymer precursors can participate in free radical reactions.

In some embodiments, the first photopolymer precursor and second photopolymer precursor may include, for example, trimethylolpropane ethoxylate triacrylate, poly(ethylene glycol) diacrylate, pentaerythritol tetraacrylate, ethylene glycol diacrylate, trimethylolpropane ethoxylate triacrylate, 2-hydroxyethyl methacrylate, pentaerythritol triacrylate, or a combination thereof.

In some embodiments, the first photopolymer precursor and second photopolymer precursor may include the same polyethylene glycol functional group as the nanoparticles to ensure that the nanoparticles have excellent miscibility and dispersity in the polymer precursors.

In some embodiments, the first photopolymer precursor and second photopolymer precursor may both be included in the light-sensitive material 15 at a ratio, relative to each other, that ranges from 1:3 to 3:1. For example, in some embodiments, the first photopolymer precursor and second photopolymer precursor may both be included in the light-sensitive material 15 at a ratio, relative to each other, that ranges from 1:3 to 1:2, 1:3 to 2:1, 2:1 to 3:1, or 1:2 to 3:1, respectively. In some embodiments, the light-sensitive material 15 may include the one or more photopolymer precursors, such as a first and second photopolymer precursors, in a range from a lower limit selected from 40, 45, 50, 55, 60, 65 and 70 wt % to an upper limit selected from 45, 50, 55, 60, 65, 70, 75, and 80 wt %, where any lower limit may be paired with any mathematically feasible upper limit.

In some embodiments, the photoinitiator may be, for example, 4,4′-bis(diethylamino)benzophenone, 2-benzyl-2-(dimethylamino)-4′-morpholinobutyrophenone, phenylbis(2,4,6-trimethylbenzoyl) phosphine oxide, diphenyl (2,4,6-trimethylbenzoyl) phosphine oxide, acetophenone, thioxanthen-9-one, 2-benzyl-2-(dimethylamino)-4′-morpholinobutyrophenone, or a combination thereof. In some embodiments, the light-sensitive material 15 may include the photoinitiator in an amount ranging from 0.1, 0.2, 0.4, 0.6, 1.0, 1.3, and 1.5 wt % to 0.3, 0.5, 0.7, 1, 1.2, 1.5, 1.8 and 2.0 wt %, where any lower limit may be paired with any mathematically feasible upper limit.

In some embodiments, the photoinhibitor may be any polymerization inhibitor that is capable of dissolving in the photopolymer precursor or mixture thereof. For example, in one or more embodiments, the photoinhibitor may be one or more selected from a list including hydroquinone, 4-methoxyphenol, mequinol, butylated hydroxytoluene, quinone methide, or a combination thereof. In some embodiments, the light-sensitive material 15 may include the photoinitiator in an amount ranging from 0.05, 0.08, 0.10, 0.20, 0.30, 0.40, 0.50 and 0.60 wt % to 0.10, 0.15, 0.20, 0.30, 0.40, 0.50, 0.60, 0.80, and 1.00 wt %, where any lower limit may be paired with any mathematically feasible upper limit.

In some embodiments, the light-sensitive material 15 may include one or more rare earth salts of Er³⁺, Tm³⁺, Yb³⁺, Eu³⁺ and Nd³⁺ such as erbium (III) chloride hexahydrate, ytterbium (III) chloride hexahydrate, thulium (III) chloride hexahydrate and europium (III) chloride hexahydrate, Neodymium (III) chloride hydrate, or a combination thereof. In some embodiments, the light-sensitive material 15 may include one or more rare earth salts in an amount ranging from 1.0, 1.5, 2.0, 2.5, and 3.0 wt % to 2.0, 2.5, 3.0, 3.5, 4.0, and 5.0 wt %, where any lower limit may be paired with any mathematically feasible upper limit.

According to the system for fabricating printed particles (i.e., the target article) by two-photon polymerization using the femtosecond laser 11, the image capture apparatus 13 may be arranged in the light path for fabricating the printed particles using the femtosecond lasers 11. This arrangement allows a single beam of femtosecond lasers 11 to be divided into multiple parallel beams, enabling simultaneous solidification of multiple target articles. Additionally, it enables one-time projection forming for each layer of the cross-sectional graphs of the target article, with each layer potentially being different. Consequently, this system can fabricate complex three-dimensional target articles, significantly improving fabrication efficiency and process flow.

Moreover, during the layer-by-layer solidification process, the displacement platform only needs to move along the direction of the cross-sectional thickness of the target article, eliminating the need for point-by-point movement along the two-dimensional plane. This approach substantially reduces the time required to form each layer of the target article, enhances fabrication efficiency and process flow, and lowers the positioning precision requirements in the two-dimensional plane. As a result, the fabrication process is simplified, and the difficulty is reduced.

In some embodiments, the printed particles may be ball-shaped, ellipsoid-shaped, rhombohedron-shaped, tetrahedron-shaped, cube-shaped, cuboid-shaped, or other applicable shapes.

In some embodiments, the dimension of the printed particles may be between about 20 nm and about 200 nm, between about 30 nm and about 180 nm, between about 40 nm and about 150 nm, between about 50 nm and about 100 nm, or between about 20 nm and 50 nm. In some embodiments, the standard deviation of the dimension of the printed particles may be between about 1 nm and about 10 nm, between about 1 nm and about 5 nm, or between about 1 nm and about 3 nm. In some embodiments, the standard deviation of the dimension of the printed particles may be less than 2 nm.

In some embodiments, the printed particles may be in conjunction with filtration process(es) to further reduce the dimension variations between printed particles.

FIG. 2 is a flow chart illustrating the method 10 for the fabricating the printed particles by two-photon polymerization using a femtosecond laser of the present disclosure.

With reference to FIGS. 2, at step S11, the light-sensitive material 15 may be prepared and placed on the displacement platform 16.

With reference to FIGS. 2, at step S13, the femtosecond laser 11 may be activated to generate femtosecond laser beams.

With reference to FIG. 2, at step S15, the femtosecond laser beams may be modulated with the external light path modulation unit 12.

With reference to FIGS. 2, at step S17, the image capture apparatus 13 may be controlled by the computer 17 to capture a first layer of cross-section graphs of the printed particles (i.e., the target article), such that the modulated femtosecond laser beams form parallel beams arranged according to the first layer of cross-section graphs.

With reference to FIGS. 2, at step S19, the parallel beams may be focused by the focusing lens 14 in the light-sensitive material 15 to form a planar graph composed of multiple focal points, where the light-sensitive material at all focal points is solidified, thereby achieving one-time projection forming for the first layer of cross-section structures of the first layer of cross-section graphs of the printed particles.

With reference to FIGS. 2, at step S21, the displacement platform 16 may be controlled by the computer 17 to move by a distance equal to the thickness of one layer of the cross-section of the printed particles, with the movement direction of the displacement platform being parallel to the direction in which the femtosecond laser beams radiate the light-sensitive material.

With reference to FIGS. 2, at step S23, the image capture apparatus 13 may be controlled by the computer 17 to capture subsequent layers of cross-section graphs of the printed particles layer by layer.

With reference to FIGS. 2, at step S25, after each subsequent layer of cross-section graphs of the printed particles is formed, the displacement platform 16 may be controlled by the computer 17 to move by a distance equal to the thickness of one layer of the cross-section of the printed particles until the printed particles are formed.

In some embodiments, the polishing composition may include substantially any suitable amount of the above described (colloidal) printed particles. For example, the polishing composition may include about 0.01 wt. % or more printed particles at point of use (e.g., about 0.05 wt. % or more, about 0.1 wt. % or more, about 0.2 wt. % or more, about 0.3 wt. % or more, about 0.4 wt. % or more, or about 0.5 wt. % or more). The amount of printed particles in the polishing composition may include about 20 wt. % or less at point of use (e.g., about 20 wt. % or less, about 5 wt. % or less, or about 3 wt. % or less, about 2 wt. % or less, or even about 1 wt. % or less). Accordingly, it will be understood that the amount of printed particles may be in a range bounded by any two of the aforementioned endpoints, for example, in a range from about 0.01 wt. % to about 20 wt. % at point of use (e.g., from about 0.1 wt. % to about 10 wt. %, from about 0.1 wt. % to about 5 wt. %, from about 0.1 wt. % to about 3 wt. %, or from about 0.2 wt. % to about 3 wt. %).

The liquid carrier is generally used to facilitate the application of the abrasive (the printed particles) and any optional chemical additives to the surface of the substrate to be polished (e.g., planarized). The liquid carrier may be any suitable carrier (e.g., a solvent) including lower alcohols (e.g., methanol, ethanol, etc.), ethers (e.g., dioxane, tetrahydrofuran, etc.), water, and mixtures thereof. In some embodiments, the liquid carrier comprises, consists essentially of, or consists of water, more preferably deionized water.

In some embodiments, the printed particles may have a positive charge in the polishing composition (e.g., in the liquid carrier). The charge on the printed particles is commonly referred to as the zeta potential (or the electrokinetic potential). The zeta potential of a particle refers to the electrical potential difference between the electrical charge of the ions surrounding the particle and the electrical charge of the bulk solution of the polishing composition (e.g., the liquid carrier and any other components dissolved therein).

In some embodiments, the printed particles may have a positive charge in the polishing composition of about 10 mV or more (e.g., about 15 mV or more, about 20 mV or more, or about 25 mV or more). In some embodiments, printed particles may have a positive charge in the polishing composition of about 60 mV or less (e.g., about 55 mV or less or about 50 mV or less). Accordingly, it will be understood that the printed particles may have a positive charge in the polishing composition in a range bounded by any one of the aforementioned endpoints, for example, in a range from about 10 mV to about 60 mV (e.g., about 15 mV to about 60 mV, or about 25 mV to about 50 mV).

While the present disclosures are not limited in this regard, the printed particles may advantageously have a permanent positive charge. By permanent positive charge it is meant that the positive charge on the printed particles is not readily reversible, for example, via flushing, dilution, filtration, and the like. A permanent positive charge may be the result, for example, of covalently bonding a cationic compound with the printed particles. A permanent positive charge is in contrast to a reversible positive charge that may be the result, for example, of an electrostatic interaction between a cationic compound and the printed particles.

In some embodiments, the printed particles may alternatively have a non-permanent positive charge imparted thereto, for example, via contact with a cation-containing component (i.e., a positively charged species) in the liquid carrier. A non-permanent positive charge may be achieved, for example, via treating the printed particles with at least one cation-containing component, for example, selected from ammonium salts (preferably quaternary amine compounds), phosphonium salts, sulfonium salts, imidazolium salts, and pyridinium salts.

In some embodiments, the polishing composition may have substantially any suitable pH depending on the intended application. In other words, the polishing composition may be acidic, neutral, or alkaline. In part to minimize safety and shipping concerns, the pH is generally in a range from about 2 to about 12 (e.g., from about 2 to about 6, from about 5 to about 9, or from about 8 to about 12). In some embodiments, the pH of the polishing composition may be in a range from about 1 to about 6 (e.g., from about 1 to about 5, from about 2 to about 5, or from about 2 to about 4).

The pH of the polishing composition may be achieved and/or maintained by any suitable means. The polishing composition may include substantially any suitable pH adjusting agents or buffering systems. For example, suitable pH adjusting agents may include nitric acid, sulfuric acid, phosphoric acid, phthalic acid, citric acid, adipic acid, oxalic acid, malonic acid, maleic acid, ammonium hydroxide, and the like while suitable buffering agents may include phosphates, sulfates, acetates, malonates, oxalates, borates, ammonium salts, and the like.

In some embodiments, the polishing composition may include substantially any suitable chemical additives. In some embodiments, the polishing composition configured for polishing a metal layer may include, for example, one or more of the following components: an oxidizing agent, a chelating agent, a polishing rate accelerating agent, a catalyst, a polishing rate inhibitor, a topography control agent, an etch inhibitor, pH buffering agents, dispersants, and biocides. In some embodiments, the polishing composition configured for polishing a dielectric layer may include, for example, one or more of the following components: cationic, anionic, or nonionic polymers, secondary polishing rate accelerators or inhibitors (e.g., for nitride layers), dispersants, conditioners, scale inhibitors, chelating agents, stabilizers, pH buffering agents, and biocides. Such additives are purely optional. The disclosed embodiments are not so limited and do not require the use of any one or more of such additives.

In some embodiments, the polishing composition may include an oxidizing agent. The oxidizing agent may be added to the polishing composition during the slurry manufacturing process or just prior to the CMP operation (e.g., in a tank located at the semiconductor fabrication facility). In some embodiments, the oxidizing agent may include inorganic or organic per-compounds. A per-compound as defined herein is a compound containing at least one peroxy group (—O—O—) or a compound containing an element in its highest oxidation state. Examples of compounds containing at least one peroxy group include but are not limited to hydrogen peroxide and it adducts such as urea hydrogen peroxide and percarbonates, organic peroxides such as benzoyl peroxide, peracetic acid, and di-t-butyl peroxide, monopersulfates (SO₅⁻), dipersulfates (S₂O₈⁻), and sodium peroxide. Examples of compounds containing an element in its highest oxidation state include but are not limited to periodic acid, periodate salts, perbromic acid, perbromate salts, perchloric acid, perchlorate salts, perboric acid, and perborate salts and permanganates. The most preferred oxidizing agent is hydrogen peroxide.

In some embodiments, the oxidizing agent may be present in the polishing composition in an amount ranging, for example, from about 0.1 to about 20 wt. % at point of use. For example, in embodiments in which a hydrogen peroxide oxidizer and a soluble accelerator are used, the oxidizer may be present in the polishing composition in an amount ranging from about 0.1 wt. % to about 10 wt. 9% at point of use (e.g., from about 1 wt. % to about 10 wt. %, from about 1 wt. % to about 5 wt. %).

In some embodiments, the polishing composition may include inhibitors. In some embodiments, the inhibitors include compounds having nitrogen containing functional groups such as nitrogen containing heteroycles, alkyl ammonium ions, amino alkyls, and amino acids. Useful amino alkyl corrosion inhibitors include, for example, hexylamine, tetramethyl-p-phenylene diamine, octylamine, diethylene triamine, dibutyl benzylamine, aminopropylsilanol, aminopropylsiloxane, dodecylamine, mixtures thereof, and synthetic and naturally occurring amino acids including, for example, lysine, tyrosine, glutamine, glutamic acid, cystine, and glycine (aminoacetic acid).

In some embodiments, the inhibitor compound may alternatively and/or additionally include an amine compound in solution in the liquid carrier. The amine compound (or compounds) may include a primary amine, a secondary amine, a tertiary amine, or a quaternary amine. The amine compound may further include a monoamine, a diamine, a triamine, a tetramine, or an amine based polymer having a large number of repeating amine groups (e.g., 4 or more amine groups).

In some embodiments, the inhibitor compound may further include a cationic polymer. Example cationic polymers include but are not limited to poly(vinylimidazolium), poly(methacryloyloxyethyltrimethylammonium) chloride (polyMADQUAT), poly(diallyldimethylammonium) chloride (polyDADMAC) (i.e., Polyquaternium-6), poly(dimethylamine-co-epichlorohydrin), poly [bis(2-chloroethyl) ether-alt-1,3-bis[3-(dimethylamino)propyl]urea] (i.e., Polyquaternium-2), copolymers of hydroxyethyl cellulose and diallyldimethylammonium (i.e., Polyquaternium-4), copolymers of acrylamide and diallyldimethylammonium (i.e., Polyquaternium-7), quaternized hydroxyethylcellulose ethoxylate (i.e., Polyquaternium-10), copolymers of vinylpyrrolidone and quaternized dimethylaminoethyl methacrylate (i.e., Polyquatemium-11), copolymers of vinylpyrrolidone and quaternized vinylimidazole (i.e., Polyquatemium-16), Polyquaternium-24, a terpolymer of vinylcaprolactam, vinylpyrrolidone, and quaternized vinylimidazole (i.e., Polyquaternium-46), 3-Methyl-1-vinylimidazolium methyl sulfate-N-vinylpyrrolidone copolymer (i.e., Polyquaternium-44), and copolymers of vinylpyrrolidone and diallyldimethylammonium.

In some embodiments, the inhibitor compound may include a cationic polymer having an amino acid monomer (such compounds may also be referred to as polyamino acid compounds). In some embodiments, the polyamino acid compounds may include substantially any suitable amino acid monomer groups, for example, including polyarginine, polyhistidine, polyalanine, polyglycine, polytyrosine, polyproline, and polylysine. In some embodiments, polylysine is a preferred polyamino acid. It will be understood that polylysine may include-polylysine and/or α-polylysine composed of D-lysine and/or L-lysine. The polylysine may thus include α-poly-L-lysine, α-poly-D-lysine, ε-poly-L-lysine, ε-poly-D-lysine, and mixtures thereof. It will further be understood that the polyamino acid compound (or compounds) may be used in any accessible form, e.g., the conjugate acid or base and salt forms of the polyamino acid may be used instead of (or in addition to) the polyamino acid.

In some embodiments, the polishing compositions may include substantially any suitable concentration of the inhibitor compound. In general, the concentration is desirably high enough to provide adequate etch inhibition, but low enough so that the compound is soluble and so as not to reduce polishing rates below acceptable levels. By soluble it is meant that the compound is fully dissolved in the liquid carrier or that it forms micelles in the liquid carrier or is carried in micelles. It may be necessary to vary the concentration of the inhibitor compound depending upon numerous various factors, for example, including the solubility thereof, the number of amine groups therein, the length of an alkyl group, the relationship between etch rate inhibition and polishing rate inhibition, the oxidizing agent used, the concentration of the oxidizing agent, and so on. In certain desirable embodiments, the concentration of an amine compound in the polishing composition may be in a range from about 0.1 μM to about 10 mM at point of use (i.e., from about 10⁻⁷ to about 10⁻² molar). For example, in embodiments utilizing a polymeric inhibitor such as a cationic polymer, the concentration may be on the lower end of the range (e.g., from about 10⁻⁷ to about 10⁻⁴ molar at point of use). In other embodiments utilizing a non-polymeric compound, (having fewer cationic groups and a lower molecular weight), the concentration may be on the higher end of the range (e.g., from about 10⁻⁵ to about 10⁻² molar at point of use).

In some embodiments, the polishing composition may include a biocide. The biocide may include any suitable biocide, for example an isothiazolinone biocide. The amount of biocide in the polishing composition typically is in a range from about 1 ppm to about 50 ppm at point of use or in a concentrate, and preferably from about 1 ppm to about 20 ppm.

In some embodiments, the polishing composition may be prepared by combining the components thereof in any order. The term “component” as used herein includes the individual ingredients (e.g., the printed particles, the accelerator, the amine compound, etc.).

In some embodiments, the polishing composition components (such as an accelerator, a stabilizer, an etching inhibitor, and/or a biocide) may be added directly to the printed particles dispersed in the liquid carrier. In some embodiments, multiple batches of printed particles (e.g., first printed particles and second printed particles) may be fabricated separately with different physical properties (e.g., shape, dimension, surface charge etc.). The first and second printed particles may be mixed together prior to adding the other polishing composition components. In some embodiments, the other components may be added to one of the printed particles prior to mixing the first and second printed particles together. The printed particles and the other components may be blended together using any suitable techniques for achieving adequate mixing. An optional oxidizing agent may be added at any time during the preparation of the polishing composition. For example, the polishing composition may be prepared prior to use, with one or more components, such as the oxidizing agent, being added just prior to the CMP operation (e.g., within about 1 minute, or within about 10 minutes, or within about 1 hour, or within about 1 day, or within about 1 week of the CMP operation). The polishing composition may also be prepared by mixing the components at the surface of the substrate (e.g., on the polishing pad) during the CMP operation.

In some embodiments, the polishing composition may also be provided as a concentrate which is intended to be diluted with an appropriate amount of water prior to use. In some embodiments, the polishing composition concentrate may include the printed particles, water, and other optional components such as an accelerator, a stabilizer, an etch inhibitor, and a biocide, with or without the oxidizing agent, in amounts such that, upon dilution of the concentrate with an appropriate amount of water, and an optional oxidizing agent if not already present in an appropriate amount, each component of the polishing composition will be present in the polishing composition in an amount within the appropriate ranges recited above for each component. For example, the printed particles and other optional components may each be present in the polishing composition in an amount that is about 2 times (e.g., about 3 times, about 4 times, about 5 times, or even about 10 times) greater than the point of use concentrations recited above for each component so that, when the concentrate is diluted with an equal volume of (e.g., 2 equal volumes of water, 3 equal volumes of water, 4 equal volumes of water, or even 9 equal volumes of water respectively), along with the oxidizing agent in a suitable amount, each component will be present in the polishing composition in an amount within the ranges set forth above for each component. In some embodiments, the concentrate may contain an appropriate fraction of the water present in the final polishing composition in order to ensure that other components are at least partially or fully dissolved in the concentrate.

In some embodiments, the polishing compositions may be used to polish substantially any substrate, for example, including a dielectric layer and/or a metal layer such as a tungsten layer, a copper layer, an aluminum layer, a cobalt layer, and/or a barrier layer such as a titanium layer, a titanium nitride layer, a tantalum layer, and/or a tantalum nitride layer.

One aspect of the present disclosure provides a polishing composition including a liquid carrier; and printed particles dispersed in the liquid carrier. The printed particles are fabricated by additive manufacturing.

Another aspect of the present disclosure provides a polishing composition including a liquid carrier; first printed particles dispersed in the liquid carrier; and second printed particles dispersed in the liquid carrier. The first printed particles and the second printed particles are fabricated by additive manufacturing. A dimension of the first printed particles and a dimension of the second printed particles are different.

Another aspect of the present disclosure provides a method for fabricating printed particles including preparing a light-sensitive material and placing the light-sensitive material on a displacement platform; activating a femtosecond laser to generate femtosecond laser beams; modulating the femtosecond laser beams with an external light path modulation unit; using a computer to control an image capture apparatus to capture a first layer of cross-section graphs of the printed particles, such that the modulated femtosecond laser beams form parallel beams arranged according to the first layer of cross-section graphs; focusing the parallel beams, by focusing lens, in the light-sensitive material to form a planar graph composed of multiple focal points, where the light-sensitive material at all focal points is solidified, thereby achieving one-time projection forming for the first layer of cross-section structures of the first layer of cross-section graphs of the printed particles; using the computer to control the displacement platform to move by a distance equal to the thickness of one layer of the cross-section of the printed particles, with the movement direction of the displacement platform being parallel to the direction in which the femtosecond laser beams radiate the light-sensitive material; controlling the image capture apparatus, via the computer, to capture subsequent layers of cross-section graphs of the printed particles layer by layer; and after a subsequent layer of cross-section graphs of the printed particles is formed, using the computer to control the displacement platform to move by a distance equal to the thickness of one layer of the cross-section of the printed particles until the printed particles are formed.

Due to the use of printed particles formed by additive manufacturing, which exhibit less structural variation (e.g., shape, dimension, surface charge) between individual particles, the batch-to-batch variation in CMP operations using the polishing composition may be reduced. As a result, the process stability of CMP operations may be improved, and process control may be simplified. Furthermore, the shape, dimension, surface charge, polarity, and size distribution of the printed particles can be customized by additive manufacturing to meet the requirements of various processes.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, and steps.

What is claimed is:

1. A polishing composition, comprising:
a liquid carrier;
first printed particles dispersed in the liquid carrier; and
second printed particles dispersed in the liquid carrier;
wherein the first printed particles and the second printed particles are fabricated by additive manufacturing;
wherein a dimension of the first printed particles and a dimension of the second printed particles are different.

2. The polishing composition of claim 1, wherein a standard deviation of the dimension of the first printed particles is between about 1 nm and about 10 nm and a standard deviation of the dimension of the second printed particles is between about 1 nm and about 10 nm.

3. The polishing composition of claim 1, wherein a shape of the first printed particles and a shape of the second printed particles are different.

4. The polishing composition of claim 1, wherein the first printed particles are ball-shaped, ellipsoid-shaped, rhombohedron-shaped, tetrahedron-shaped, cube-shaped, or cuboid-shaped and the second printed particles are ball-shaped, ellipsoid-shaped, rhombohedron-shaped, tetrahedron-shaped, cube-shaped, or cuboid-shaped.

5. The polishing composition of claim 1, wherein the polishing composition comprises about 0.01 wt. % of the first printed particles.

6. The polishing composition of claim 1, wherein the liquid carrier comprises lower alcohols, ethers, water, or mixtures thereof.

7. The polishing composition of claim 1, wherein a surface charge of the first printed particles and a surface charge of the second printed particles are different.

8. The polishing composition of claim 1, wherein the first printed particles have a positive charge of at least 10 mV in the liquid carrier.

9. The polishing composition of claim 1, wherein a pH of the polishing composition is between about 2 and about 12.

10. The polishing composition of claim 1, further comprising an oxidizing agent.

11. The polishing composition of claim 10, wherein the oxidizing agent comprises hydrogen peroxide, urea hydrogen peroxide, benzoyl peroxide, peracetic acid, or di-t-butyl peroxide.

12. The polishing composition of claim 10, wherein the polishing composition comprises about 0.1 to about 20 wt. % of the oxidizing agent.

13. The polishing composition of claim 1, further comprising an inhibitor.

14. The polishing composition of claim 13, wherein the inhibitor comprises heterocycles, alkyl ammonium ions, amino alkyls, or amino acids.

15. The polishing composition of claim 1, further comprising a biocide.
